(19) United States
(12) Patent Application Publication
(10) Pub. No.: US 2021/0220915 A1
(43) Pub. Date: Jul. 22, 2021

(54) METHOD FOR IMPLEMENTING A MEASUREMENT SYSTEM EMBEDDED IN A COMPONENT OBTAINED BY POWDER MICRO-MELTING

(71) Applicant: PRES-X S.R.L., 42048 RUBIERA (REGGIO EMILIA) (IT)

(72) Inventors: GIORGIO DE PASQUALE, OCCHIEPPO INFERIORE (IT); MAURIZIO ROMEO, CAMERI (IT)

(21) Appl. No.: 17/051,491

(22) PCT Filed: May 2, 2019
(86) PCT No.: PCT/IB2019/053581

§ 371 Date: Oct. 29, 2020

(30) Foreign Application Priority Data
May 2, 2018 (IT) 102018000005012

(51) Int. Cl. B22F 10/20; B22F 10/70; B33Y 50/02; B22F 10/30; B33Y 10/00; B33Y 80/00

(52) U.S. Cl. CPC B22F 10/20; B22F 10/70; B33Y 80/00; B22F 10/30; B33Y 10/00; B33Y 50/02

(57) ABSTRACT

Method for implementing a measurement system embedded in a device (D) obtained by powder micro-melting, comprising the steps of: —manufacturing (100), by using a micro-melting technique, a covering element (30), —manufacturing (200), by using a micro-melting technique, a base portion (10) of the device (D) comprising a work chamber that comprises a sensor seat (15), interrupting (300) the micro-melting process once the top of the sidewalls of the base portion (10) of the device (D) has been reached, opening said work chamber formed by the sensor seat (15), and exposing the semifinished device (D) to the atmosphere, —removing (400) the unmelted metal powder that is present within the sensor seat (15), —positioning (500) the sensor (20) within the sensor seat (15), —positioning (600) said covering element (30), previously manufactured during the first step (100), over the sensor seat (15) containing the sensor (20), and restoring the inertization of the work chamber and the controlled internal atmosphere, and—resuming (700) the micro-melting process to form, on the covering element (30), a closing element (40) by completely coating the surface with a new layer of powder, which is then micro-melted, and continuing the normal micro-melting process until the device (D) is complete.

### FIELD OF THE INVENTION

The present invention relates to techniques for integrating sensors within free-form components obtained by powder micro-melting, which are not subject to common geometric production constraints.

The solution according to the present invention allows avoiding the common problems suffered by the solutions currently known in the art, which problems relate to high temperatures, removal of residual powders, and compatibility with currently available processes and plants.

More in detail, the invention tackles the problem of integrating sensors within devices manufactured by powder micro-melting processes.

Therefore, the invention proposes a method for embedded sensorization of free-form components obtained by powder micro-melting.

### BACKGROUND ART

The techniques currently employed for installing sensors in devices obtained by powder micro-melting require the use of conventional interfaces, such as adhesives, threaded connections, etc.

Several documents exist which describe known solutions, some of which will be commented on below. Such comments are useful to introduce and underline the drawbacks of the solutions that are available today.

Document US 2017/0140956 A1, “Single piece ceramic platen” describes a solution for inserting heating/cooling fluids within channels of a ceramic component obtained by metal powder micro-melting. The solution uses a mixture of ceramic powder and a binding agent. The described solution provides for forming channels of reduced section, through which such heating/cooling fluids are introduced into the component. This solution does not envisage the possibility of installing discrete sensors during the process of forming the ceramic component.

Document US 2017/0157857 A1, “Adjusting process parameters to reduce conglomerated powder”, describes a solution for subjecting the powder to a pre-heating treatment in order to promote the creation of cavities within a device without the presence of any undesired solid artifacts in the final component. In this case as well, the described solution does not envisage the installation of any sensors in the device, since it only discloses a powder pre-heating technique.

Document GB 2538874 A, “Selective Laser Melting”, describes a method of additive manufacturing from a powder bed for micro-melting of high melting point materials.

Document WO 2014/166567 A1, “Temperature regulation for a device for the additive manufacturing of components and corresponding production method”, describes a device for making components by additive manufacturing based on powder micro-melting, equipped with a winding for inductive heat generation.

Article by X. Li, “Embedded sensors in layered manufacturing”, Stanford Univ., 2001 describes the insertion of unidimensional sensors (e.g. optical fibers) into components obtained by layer stratification. This document describes a different production technology, which is not based on powder micro-melting.

Article by R. Maier et al., “Embedded fiber optic sensors within additive layer manufactured components”, IEEE Sensors Journal, 2013 describes the insertion of optical fibers into components obtained by layer stratification through the use of a different production technology, which is not based on powder micro-melting.

Article by T. Vasilevitsky et al., “Steel-sense: integrating machine elements with sensors by additive manufacturing”, describes the installation of sensors by means of conventional interfaces to components obtained by additive manufacturing. It describes an external, as opposed to embedded, installation of sensors to the device.

The solutions currently known do not envisage cooperation or coexistence of the principle of embedded sensorization within the component or device with the powder micro-melting technology.

### OBJECT AND SUMMARY

A need is therefore felt for solutions that will allow overcoming the above-mentioned drawbacks.

The solution proposed herein allows overcoming the drawbacks of the prior art techniques by means of a method according to claim 1.

The main advantage given by the solution described herein relates to high-performance, high-capacity structural monitoring.

The solution described herein allows manufacturing free-form metal components based on powder micro-melting technology and equipped with sensors embedded in the component itself.

In particular, the powder micro-melting manufacturing processes can be chosen among SLM (Selective Laser Sintering), EBM (Electron Beam Melting) and FDM (Fused Deposition Modeling).

Compared to the state of the art, device sensorization is embedded and invisible, protected against contamination and interference, positioned in places that are most functionally effective (because they are close to the source of the quantity to be measured by the sensor).

Sensors are currently located, by means of traditional connections and interfaces (glueing, adhesives and threaded connections), in external positions, which are vulnerable to mechanical shocks and noise, and are often far from the source of the quantity to be measured.

The innovative character of the production method lies in the sequence of steps necessary for integrating electronic elements notwithstanding the constraints inherent in the process (very high temperatures, presence of metal powder, etc.)

Some examples of application of the solution proposed herein are as follows:
support elements for transmission members (e.g. ball/roller bearings, sliding bearings, recirculating ball screws, etc.),
fixed or moving/rotary transmission members (e.g. shafts, toothed wheels, elements of kinematic chains, etc.); for moving or rotary members, the absence of power wires will make it possible to carry out monitoring operations with no physical constraints,
body prostheses,
moulds for melting polymers/metals, and
structural elements of chassis, frames and structures of machines and vehicles, also for aeronautical use.

A further object of the present invention is to provide a measurement system embedded in a device obtained by powder micro-melting, comprising the steps of:
manufacturing, by using a micro-melting technique, a covering element,
manufacturing, by using a micro-melting technique, a base portion of the device comprising a work chamber that comprises a sensor seat,
interrupting the micro-melting process once the top of the sidewalls of the base portion of the device is reached, opening the work chamber formed by the sensor seat, and exposing the semifinished device to the atmosphere,
removing the unmelted metal powder that is present within the sensor seat,
positioning the sensor within the sensor seat,
positioning the covering element, previously manufactured during the first step, over the sensor seat containing the sensor, and restoring the inertization of the work chamber and the controlled internal atmosphere, and
resuming the micro-melting process to form, on the covering element, a closing element by completely coating the surface with a new layer of powder, which is then micro-melted, and continuing the normal micro-melting process until the device is complete.

In several embodiments, during the step of manufacturing a device by using a micro-melting technique, a cable seat is also formed, in addition to the sensor seat, for the passage of a power supply and/or data transmission cable connected to the sensor.

In several embodiments, during the step of manufacturing a device by using a micro-melting technique, the work chamber is kept under controlled atmosphere by blowing an inert gas, for the purpose of evacuating the melting fumes and any combustion residues.

In several embodiments, in particular, during the step of removing the unmelted metal powder that is present within the sensor seat, miniaturized aspirators and/or manual brushes are used in order to remove the powder that is present on the free top surface of the base portion of the device.

In the preferred embodiments, the removed powder is recovered and recycled. Preferably, during the step of positioning the sensor within the sensor seat, the sensor is inserted into the sensor seat by either fitting it by friction against the sidewalls or glueing it to the base of the sensor seat.

In several embodiments, at the end of the step of positioning the sensor within the sensor seat, a step of applying onto the top surface of the sensor a thermally insulating element, made of fabric of aramid fiber or other materials, is carried out in order to protect the sensor during the next step of resuming the micro-melting process.

Still with reference to the preferred embodiments, at the end of the step of positioning the covering element over the sensor seat containing the sensor, the surfaces of the covering element and of the base portion of the device are aligned by mechanical or manual fine positioning.

Finally, in several embodiments, prior to resuming the micro-melting process to form a closing element on the covering element, the exact thickness of the powder layer on the covering element is restored to obtain a powder layer that is even throughout its extension, and the passage of the powder deposition carriage is checked to prevent it from displacing the covering element of the sensor.

Preferably, the sensor is formed by multiple sensors for measuring several quantities, wherein the sensors are positioned at different heights/depths/positions in the same device within respective sensor seats.

### BRIEF DESCRIPTION OF THE DRAWINGS

Further features and advantages of the invention will be illustrated in the following detailed description, which is provided merely by way of non-limiting example with reference to the annexed drawings, wherein:

FIG. 1 is an exploded view of one example of embodiment of a device according to the present invention, and

FIG. 2 is a sectional view of the device of FIG. 1.

### DETAILED DESCRIPTION

The following description will illustrate various specific details useful for a deep understanding of some examples of one or more embodiments. The embodiments may be implemented without one or more of such specific details or with other methods, components, materials, etc. In other cases, some known structures, materials or operations will not be shown or described in detail in order to avoid overshadowing various aspects of the embodiments. Any reference to “an embodiment” in this description will indicate that a particular configuration, structure or feature is comprised in at least one embodiment. Therefore, the phrase “in an embodiment” and other similar phrases, which may be present in different parts of this description, will not necessarily be all related to the same embodiment. Furthermore, any particular configuration, structure or feature may be combined in one or more embodiments as deemed appropriate.

The references below are therefore used only for simplicity's sake, and do not limit the protection scope or extension of the various embodiments.

Powder micro-melting processes are based on localized concentration of a heat source (e.g. a laser beam or an electron beam) capable of causing a state change in the metal with a high degree of dimensional detail.

The initial metal powder, disposed on a bed, undergoes a process of melting and subsequent solidification in successive superimposed layers, until the desired final geometry is obtained.

Suitable systems currently available on the market can manage the entire process, from supplying and moving the powder to controlling the atmosphere, the heat source and the handling of the workpiece being manufactured.

Powder micro-melting technologies are dedicated to metal materials (typically aluminium or titanium alloys, steel and nickel-based materials).

Powder micro-melting technologies have become increasingly widespread in the last decade due to the development of the production chain connected to “additive manufacturing”, including dedicated design systems (software for topological optimization and machine setup), refined production and powder-control techniques, stable processes and machines, suitably tuned post-production thermal treatments, and increased final users' awareness of the new technology.

The main advantages associated with components obtained by powder micro-melting certainly include the possibility of manufacturing components having high geometrical complexity (free-form components) with less or no process complications.

This feature meets requirements in terms or weight reduction, local strain control, local control of forced cooling, increased versatility of moulds and prototypes.

The present invention relates to a method for manufacturing components, the execution of which is associated with a micro-melting process. The solution described herein aims at improving the performance of the manufactured components by providing them with embedded sensors.

The solution considered herein comes from a deep knowledge of the process and of the management and experimentation of the same, which is the result of years of experience in the industrial field.

As already anticipated, integration of discrete sensors within the device or component during the manufacturing thereof by powder micro-melting is currently impossible because of problems encountered in the process, such as:
difficulty in interacting with process automation and continuity, which are necessary to achieve stratification of the melted powder, and difficulty in ensuring structural continuity and good mechanical properties of the device in the event of an interruption of the process;
higher temperature due to the micro-melting process and the subsequent heat treatment, which destroys electronic components, such as sensors; and
difficulty in controlling unmelted regions in the component (e.g. in correspondence with sensor seats) because of the presence therein of residual metal powder that is difficult to remove.

The processes suitable for supporting the solution described herein, appropriately modified, include:
SLM (selective laser sintering),
EBM (electron beam melting), and
FDM (fused deposition modeling).

The method for manufacturing components according to the present invention is based on the following steps, described herein merely by way of example.

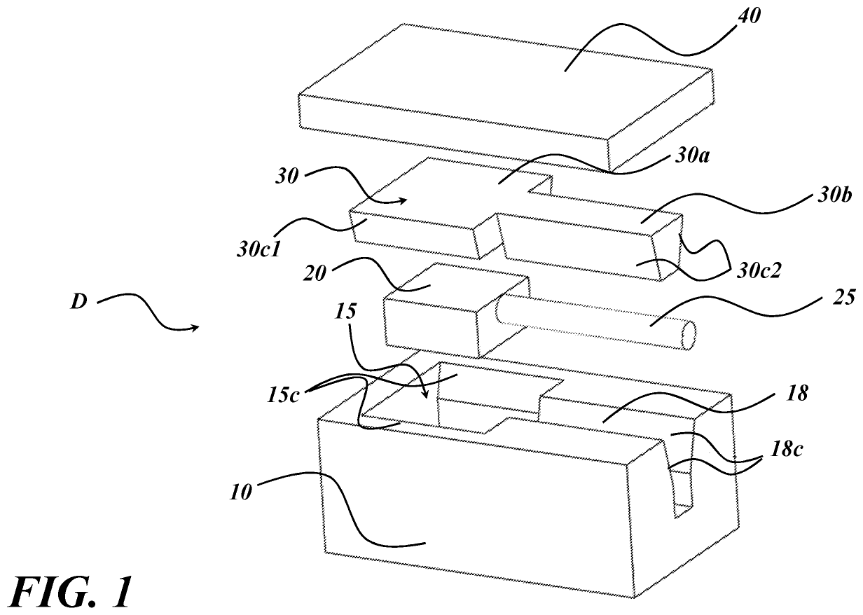

FIG. 1 is an exploded view of one possible embodiment of a device D made in accordance with the method of the present invention.

In particular, the device D comprises a base portion 10 made from micro-melted material. Inside such base portion 10 a chamber is formed, which creates a sensor seat 15 shaped for receiving therein a sensor 20 having the same basic geometry as the respective sensor seat 15.

More in detail, the sensor seat 15 may have a circular, square or any other shape, so as to be able to house a sensor 20, which may have a matching shape or a shape that allows it to be received within the sensor seat 15. The sensor seat 15 comprises a base portion 15a, a back wall 15b and two sidewalls 15c.

Typically, the dimensions of the sensor seat 15 are such as to allow the sensor 20 to be inserted therein without interference.

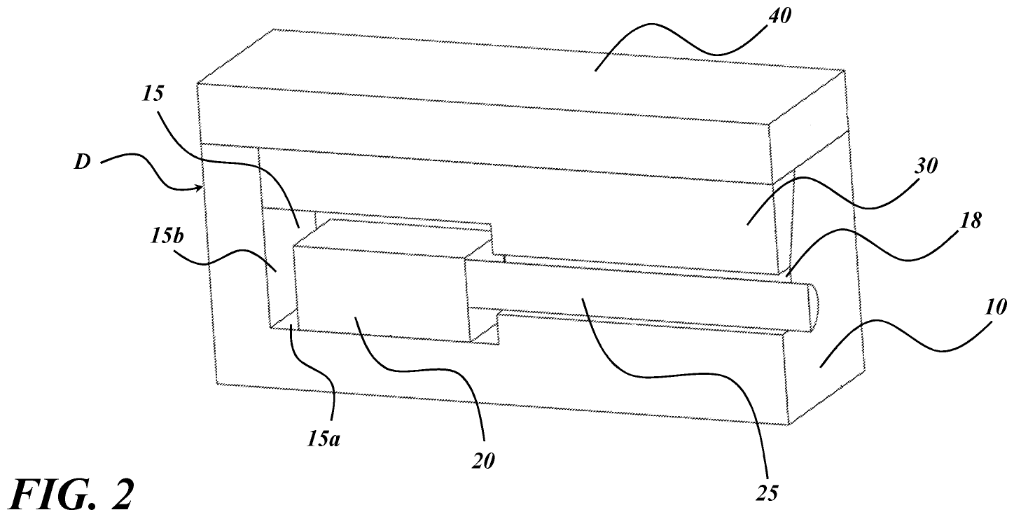

As shown more clearly in FIG. 2, the sensor 20 is housed within the sensor seat 15 with some clearance.

In several embodiments, the sensor 20 is equipped with a power and signal transmission cable 25 that is received into a corresponding cable seat 18 formed in the base portion 10 adjacent to the sensor seat 15. The cable 25 is also received in the corresponding cable seat 18 with some clearance.

Still with reference to FIG. 1, there is a covering element 30 adapted to close the chamber formed by the sensor seat 15 and the cable seat 18 in the base portion 10. In particular, the covering element 30 comprises a larger first portion 30a, adapted to cover the sensor seat 15, and a smaller lateral portion 30b, adapted to cover the cable seat 18.

The nominal dimensions of the covering element 30 are not identical to those of the sensor seat 15 and cable seat 18, but are defined after testing campaigns for evaluating contraction rates (dimensional shrinkage rates) and geometrical tolerances in order to detect differences as small as one tenth of a millimeter.

The sidewalls 30c1 and 30c2 of the covering element 30 are not vertical, but tilted by a variable angle of 5° to 30° for the purpose of ensuring correct insertion and stable positioning thereof into the respective sensor seat 15 and cable seat 18. The walls 15c of the sensor seat 15 and the walls 18c of the cable seat 18 are tilted by the same angle, except for a suitable installation gap.

Finally, a closing element 40 made of micro-melted material seals the device 10. The granulometry of the powders may vary, depending on whether a laser beam or electron beam melting process is carried out, from 12 μm to 105 μm, with a suitable Gaussian curve identifying the distribution thereof with a specific range for each system and brand.

The percent majority of the granulometry must be centered on the mean value of the respective Gaussian curve.

One of the parameters that are most representative of a perfect compliance of powders for additive manufacturing is their “flowability”, i.e. the value that identifies how easily the powder can run and be spread on the melting plane.

The higher the “flowability” is, the better the result obtained, thus ensuring perfect spreading over the entire melting plane, with no uncovered areas.

The same powder (raw material) must be carefully monitored as regards the value of the humidity contained therein.

In fact, humidity is second in the list of parameters that may more affect the quality of the final melting process.

As aforementioned, the covering element 30 may comprise one or more lateral portions 30b that can be used for covering the cable seat 18 adapted to receive the power and signal transmission cable 25 of the sensor 20. Also this lateral portion 30b is provided with sidewalls 30c2 within tolerance, tilted similarly to the main covering element 30a.

The following will describe the steps of the method according to the present invention. In a first step 100, the covering element 30 is manufactured.

In a second step 200, the device D is manufactured. In particular, the device D is manufactured in accordance with an engineering drawing comprising the base portion 10, the chamber that will form the sensor seat 15 and, possibly, one or more cable seats 18 for the passage of the power and/or data transmission cable 25.

Micro-melting goes on in successive superimposed layers, as is typical of SLM processes. More in detail, micro-melting processes utilize a laser speed of 1500 mm/sec to 4000 mm/sec.

Typically, micro-melting processes utilize a laser power of 70 W to 1 KW. In several embodiments, the hatching distance is selected between −0.2 mm and +0.1 mm. In several embodiments, the plate is heated to 150° C., when laser technology is used, or the layer is pre-heated to 740° C. to 1300° C., when EBM technology is used.

Preferably, in several embodiments the electron beam scanning speed is selected between 8000 mm/sec and 22000 mm/sec.

Finally, in several embodiments the power value is selected between 1 KW and 8 KW. In a next step 300, the micro-melting process is interrupted when the top of the sidewalls of the device 10 has been reached.

Subsequently, the work chamber, formed by the sensor seat 15 and the cable seat 18, is opened and the semifinished product is exposed to the atmosphere, which may result in undesired surface oxidation processes. In particular, during the micro-melting process, the process chamber is maintained under controlled atmosphere by blowing an inert gas, such as ARGON, in order to evacuate the melting fumes and any combustion residues. In case of an EBM process, the melting chamber and the associated electron gun are placed under a very high degree of vacuum (10⁻⁵/10⁻⁷). In this way, it is not necessary to inert the process chamber, since it is already free from oxygen, i.e. in a non-oxidative or fumeless environment.

In a subsequent step 400, the unmelted metal powder that is present in the sensor seat 15 and in the cable seat 18, if any, adapted to receive the cable 25, is manually removed. In several embodiments, the unmelted metal powder is removed by means of miniaturized aspirators and/or manual brushes. In particular, the powder that is present on the free top surface of the device D, in particular of the base portion 10, is removed. The removed powder, which has undergone no damage, is then recovered and recycled. In a further step 500, the sensor 20 is positioned within the sensor seat 15, and the power cable 25, if any, is positioned within the cable seat 18.

The sensor 20 is inserted into the sensor seat 15 in either one of the following most appropriate ways: fitting by friction against the sidewalls 15c or glueing to the base 15a of the sensor seat 15.

Furthermore, in several embodiments a thermally insulating element, made of fabric of aramid fiber or other materials, is applied onto the top surface of the sensor 20 in order to protect the sensor 20 during the subsequent resumption of the micro-melting process. Any portions of the cable 25 protruding from the base portion 10 of the device D are protected by means of temporary coverings, e.g. coverings consisting of bags, and buried into the powder that is present at the sides of the base portion 10 of the device D.

In a further step 600, the covering element 30 previously made at step 100 is positioned over the sensor seat 15 containing the sensor 20 and the cable seat 18, if any, containing the cable 25.

Subsequently, the surfaces of the covering element 30 and base portion 10 of the device D are aligned, possibly by mechanical or manual fine positioning. The inertization of the process chamber and the controlled atmosphere are then restored prior to resuming the additive manufacturing process.

In a last step 700, the micro-melting process is resumed to completely coat the surface above the covering element 30 with a new layer of powder, which is then micro-melted. This step is particularly delicate because it is necessary to restore the exact thickness of the powder layer on top of the previously inserted cover, and the whole powder layer must be perfectly even again, throughout its extension. It is also necessary to ensure that the passage of the powder deposition carriage will not move or displace the covering element 30 of the sensor 20 just positioned. The normal process continues until the device D is complete. At the end of this last step, the closing element 40 will have been fully manufactured.

In order to obtain the necessary structural continuity, the time required for the execution of steps 300-700 must be short enough to prevent the part from cooling too quickly or too long, which may result in thermal and geometrical shrinkage of the base portion 10 of the melted device D beneath the interruption layer.

Should the step of inserting the covering element 30 and restoring the powder layer last too long, there could be a risk that the same covering element 30 might no longer “fit” inside the respective seat 15,18.

In order to carry out the above-listed steps, it is necessary to interact with the automated production process and make due changes to the settings and controls included in the systems currently available on the market.

The manipulation of the base portion 10 of the device D while making and handling electric parts also requires interaction with the micro-melting chamber, the controlled atmosphere therein (to be restored after installation), and the powder bed.

Such modifications can only be made by skilled and suitably trained personnel, in that they will alter the optimal operating and safety conditions of the entire process and system. Particular care and attention should also be paid to the welding/melting of the first layer of powder after the insertion of the covering element 30, so as to not leave or create any incompletely melted regions that might jeopardize the integrity of the sensor 20 and also the proper operation of the additive melting system.

After the process, the thermal annealing treatment of the device D must be calibrated to include a suitable number of heating-cooling steps, such that the integrity of the electronic parts (sensors and any cables and connectors) will not be compromised. Therefore, traditional thermal processes are re-modulated through a sequence of heating-cooling steps that suit the thermal resistance of the electronic components. The sensors 20 employed are selected among those capable to resist micro-melting and post-process thermal annealing treatment temperatures.

Power/data transmission cables 25 are heat-shielded (e.g. by means of silicone shields or the like).

Simple sensors may be replaced with complex circuit elements consisting of measurement elements (sensors), wireless transmission elements, microcontroller elements and, possibly, a rechargeable battery, or micro-generators (integrated energy harvesters, e.g. of the piezoelectric or magnetic-inductive type).

In this case, the electronic elements of the sensor 20 will be completely internal to the component or device D, without the presence of any cable 25.

The additive technology permits inserting not only a single sensor 20, but multiple sensors 20 for measuring various quantities at different heights/depths/positions into the same sensor-carrying device.

The typology of the electronic components must be appropriately identified to meet the minimum requirements of the modified micro-melting process in terms of thermal-mechanical resistance.

Some examples of application of the solution described herein are as follows:
support elements for transmission members (e.g. ball/roller bearings, sliding bearings, recirculating ball screws, etc.);
fixed or moving/rotary transmission members (e.g. shafts, toothed wheels, elements of kinematic chains, etc.); for moving or rotary members, the absence of power wires will make it possible to carry out monitoring operations with no physical constraints;
body prostheses;
moulds for melting polymers/metals;
structural elements of chassis, frames and structures of machines and vehicles, also for aeronautical use; and
calipers for vehicular braking systems.

The solution of the invention is innovative and permits the implementation of a practice that until now could not be used because of technological constraints of the plants and physical constraints of the process itself.

The component or device D obtained by means of a process according to the invention can be equipped with embedded sensors which are invisible, bulkless, insensitive to contamination and to the outside environment, and capable of sensing physical quantities in wired or wireless mode.

Such performance will add to the already known advantages of free-form components, which are not subject to the usual geometrical constraints of technological fabrication processes.

The main advantages that can be achieved are the following:
monitoring of mechanical structures by means of sensors embedded into the components, resulting in better reliability (insensitiveness to shocks and interaction with the environment),
higher measurement precision due to the vicinity to the point to be monitored, and
application of multiple measurement points within small volumes (e.g. bearing seats), which would not be possible in case of external installation or installation through traditional drilling.

Of course, without prejudice to the principle of the invention, the forms of embodiment and the implementation details may be extensively varied from those described and illustrated herein merely by way of non-limiting example, without however departing from the protection scope of the present invention as set out in the appended claims.

1-10. (canceled)

11. Method for implementing a measurement system embedded in a device obtained by powder micro-melting, comprising the steps of:
manufacturing a covering element, by using a micro-melting technique chosen among SLM (Selective Laser Sintering), EBM (Electron Beam Melting), and FDM (Fused Deposition Modeling),
manufacturing, by using a micro-melting technique, a base portion of the device comprising a work chamber that comprises a sensor seat,
interrupting the micro-melting process once the top of the sidewalls of the base portion of the device has been reached, opening said work chamber formed by the sensor seat, and exposing the semi-finished device to the atmosphere,
removing the unmelted metal powder that is present within the sensor seat,
positioning the sensor within the sensor seat,
positioning said covering element, previously manufactured during the first step, over the sensor seat containing the sensor, and restoring the inertization of the work chamber and the controlled internal atmosphere, and
resuming the micro-melting process to form, on the covering element, a closing element by completely coating the surface with a new layer of powder, which is then micro-melted, and continuing the normal micro-melting process until the device is complete,
wherein at the end of said step of positioning the sensor within the sensor seat, a step of applying onto the top surface of the sensor a thermally insulating element, made of fabric of aramid fiber or other materials, is carried out in order to protect the sensor during the subsequent step of resuming the micro-melting process.

12. Method according to claim 11, wherein, during said step of manufacturing, by using a micro-melting technique, a device, a cable seat is also formed, in addition to said sensor seat, for the passage of a power supply and/or data transmission cable connected to the sensor.

13. Method according to claim 11, wherein, during said step of manufacturing, by using a micro-melting technique, a device, the work chamber is kept under controlled atmosphere by blowing an inert gas, for the purpose of evacuating the melting fumes and any combustion residues.

14. Method according to claim 11, wherein, during said step of removing the unmelted metal powder that is present within the sensor seat, miniaturized aspirators and/or manual brushes are used in order to remove the powder that is present on the free top surface of the base portion of the device.

15. Method according to claim 11, wherein said removed powder is recovered and recycled.

16. Method according to claim 11, wherein, during said step of positioning the sensor within the sensor seat, the sensor is inserted into the sensor seat by either fitting it by friction against the sidewalls or gluing it to the base of the sensor seat.

17. Method according to claim 11, wherein, at the end of said step of positioning said covering element over the sensor seat containing the sensor, the surfaces of the covering element and of the base portion of the device are aligned by mechanical or manual fine positioning.

18. Method according to claim 11, wherein, prior to resuming the micro-melting process to form a closing element on the covering element, the exact thickness of the powder layer on the covering element is restored to obtain a powder layer that is even throughout its extension, and the passage of the powder deposition carriage is checked to prevent it from displacing the covering element of the sensor.

19. Method according to claim 11, wherein said sensor is formed by multiple sensors for measuring various quantities, wherein said sensors are positioned at different heights/depths/positions in the same device within respective sensor seats formed in the base portion.
